(19) United States
(12) Patent Application Publication
(10) Pub. No.: US 2004/0088551 A1
(43) Pub. Date: May 6, 2004

(54) Identifying persons seeking access to computers and networks

(76) Inventors: Erez Dor, Rishon LeZion (IL); Zipora Dorit Drach, Las Vegas, NV (US)

Correspondence Address: GREER, BURNS & CRAIN, 300 S WACKER DR, 25TH FLOOR, CHICAGO, IL, 60606, US

(21) Appl. No.: 10/332,256

(22) PCT Filed: Jul. 5, 2001
(86) PCT No.: PCT/IL01/00618

(30) Foreign Application Priority Data
Jul. 5, 2000 (IL) 137181

(51) Int. Cl. H04L 9/00

(52) U.S. Cl. 713/182

(57) ABSTRACT

Method and apparatus for verifying the identity of a person seeking access to a computer, whether directly or thorough a digital network, including the Internet or to some data within the computer or a facility provided by it. The basic principle of the invention is to carry out such identification automatically by means of the person's cellular telephone, connected through a suitable adapter, to the computer with which he physically interacts. Also disclosed are means for increasing the security of the identification and the manner of using the method in a variety of applications, including approval of credit-account transactions.

### FIELD OF THE INVENTION

This invention relates to security and management of access to computer systems and to facilities provided by them. In particular it relates to verifying the identity of persons seeking such access, under a variety of configurations and types of facilities.

### BACKGROUND OF THE INVENTION

Security violations in the area of access to databases constitute a major problem for organizations that keep such databases and provide access to them over a local or wide-area network. The problem becomes particularly acute as these databases are connected to the Internet. In many countries, legislation places responsibility for the security of personal data of customers on the corporations that own or operate the databases.

There are several types of security violations, including:

Penetration into a database from outside the system (e.g. over the Internet) or from within the system (e.g. by unauthorized employees) in order to steal information or to use the information for blackmail;

Unauthorized entry into a personal computer;

Penetration into a database or an Internet site for disrupting its operation (e.g. by planting a virus);

Obtaining services on an Internet site that require fees by means of a false identity or stolen password;

Purchases over an Internet site by means of counterfeit or stolen credit accounts;

Fraud by an Internet site in that it collects a payment but does not deliver the merchandise, or charges a credit account surreptitiously.

Denial by customers of transactions concluded over the Internet.

The common element of these, and many other types of violations is the relative anonymity of users of the digital media. By overcoming this anonymity, many of the violations may be prevented, or reduced to insignificant proportions.

Many different means for increasing the security in digital systems are in use or have been proposed. Of these, the ones that are concerned with authenticating the identity of a person seeking to access a digital system or database include the following.

The basic and most prevalent means is the use of a password. Clearly, this means is easily circumvented by a determined party, by eavesdropping, by surreptitiously obtaining the password or by trial-and-error.

For high-security cases, various biometric means of personal identification are used, such as images of fingerprints or of the iris or speech sounds. Apparatus for practicing these means is relatively expensive and they have the disadvantage that once they have been cracked they cannot be replaced (unlike a password, which may be changed).

Personal identification cards, such as magnetic cards, may provide a measure of security, but they are fairly easily counterfeited, similarly to credit cards. Coded electronic chips, readable by proximity detectors, provide higher security, but are more expensive.

None of the currently known access security means answers all five of the following requirements:

Reliable security in face of all known threats;

Low acquisition cost;

Low operating costs;

Easy and inexpensive integration with all existing data management systems and data protection systems;

Operating convenience.

As will be explained below with respect to the present invention, a typical cellular telephone system has inherent security facilities built into it—especially the identification of each individual telephone—and can be used to provide security also for purposes other than its own operation. According to one prior-art method, a cellular telephone is used, in conjunction with accessing a site on the Internet, to relay the user identity to the remote site in the form of a text message. This method has two disadvantages: It involves a fee for each such message and the keying of the text message is highly inconvenient.

Methods are also known for using a cellular telephone to directly effect transactions, including the purchase of merchandise and services through some central agency. Such methods are, again, inconvenient, in that they require keying the relevant data into the telephone keyboard and, although the purchaser is reliably identified, the data transmitted, including the required password, is not always secure enough.

There is thus a need for a method and a system for securely accessing computer systems and data bases and for securely carrying out transactions over a network, whereby the user is reliably identified, the method and the system fulfilling the five requirements listed hereabove.

### SUMMARY OF THE INVENTION

The method and system of the present invention primarily serve to positively identify a person seeking access to a computer system or to some data within it, whether directly or through a communication network. The basic principle of the invention is to carry out such identification automatically by means of the person's cellular telephone, connected, possibly through a suitable adapter, to the computer with which he physically interacts. Cellular telephones, to be referred to in the sequel briefly as “cell-phones”, and particularly cell-phones of the digital type (which are becoming ever more prevalent), such as those based on the GSM method, have several desirable properties that make them highly suitable for the purpose:

Cell-phones and cellular systems are widely deployed all over the world.

Each cell-phone has a unique internally registered call number, which is read and verified during every cellular connection.

Moreover, each cell-phone has a universally unique etched ID number, which is electrically readable on demand.

Every cell-phone is registered to a person or an organization; in the latter case, a person may use the cell-phone under controlled permission.

A cell-phone is portable and easily connected to, and disconnected from, the computer; moreover it can be connected to any other of the person's computers.

If a cell-phone is lost or stolen, its use can be blocked; a cell-phone with a falsified call number can be detected when it operates simultaneously with the genuine cell-phone.

Many modern cell-phones have accessible digital storage, which can be used for additional authentication data.

A cellular communication channel is relatively secure.

The location of any active cell-phone can be determined by the cellular system to at least a cell, often to some radius within a cell.

Involving a person's digital cell-phone in a digital computer system thus provides a basically reliable means for authenticating his identity. The cell-phone can, moreover, be made digitally accessible both directly to his computer and, over the cellular network, to any remote site, thus enabling automatic operation without undue manual intervention by the person or by any other party. A cellular system, widely deployed in parallel with a computer network, thus provides an excellent basis for independent identification of a user who interacts with the network and any of its connected computers. The methods and systems of the invention concern the proper employment of a cellular system for the purpose of such identification and for lending security to many types of transactions over a computer network.

The invention contemplates several configurations, each suitable for one or more classes of applications and associated identification- and authentication needs. The manner in which the cell-phone is utilized depends on the particular configuration, as will be explained below. Basically, the invention consists of a method, which is realized in part as a program in a person's computer and which calls for the connection of the cell-phone to the computer through the adapter. In some configurations that involve remote computer sites, the realization also includes a program installed at the remote site. The invention also contemplates several additional features for increasing the security of the identification and of the data used in the process. These, in turn, call for additional software programs and/or programmable devices.

A first configuration aims at identifying a person seeking to gain access to a computer or to any local network connected thereto. In this configuration, a program according to the invention, resident in the computer, allows such access only after obtaining the person's cell-phone number (in addition to conventional identification means, such as passwords) and verifying that it is identical with the corresponding number that is obtained from the cell-phone connected to the computer. For additional security, an optional element in the program makes the cell-phone dial the number of a regular phone line to which the computer (or its local network) is connected and then verifying (in a manner that is explained below with respect to the second configuration) that a legitimate connection has been made from the indicated cell-phone; this rules out the possibility that the cell-phone has been reported as missing or stolen. Another optional security measure, aimed at allaying the possibility that the linked cell-phone is an impostor or a counterfeit, retrieves its etched ID number and compares it with the stored version. Yet another optional measure is to have the adapter activatable only by a code or a key.

A second configuration aims at identifying a person to a remote computer site (or to some facility within it or connected to it) through a wide-area network, such as the internet. Such identification may be required in order to allow the person access to certain restricted data, or even to the site as a whole, or in order to verify that he is a registered subscriber to a provided service; another case in which, the accessor's identification may be advantageously required is when a site is overloaded with accessors, as when under a malicious massive attack, and it is decided to limit access to only identifiable parties. In this configuration, a program at the remote site and a program in the person's local computer cooperate as follows: The remote site sends to the local computer a number of a telephone line to which the remote site is connected; this number is fed to the cell-phone, which is made to dial it; upon receiving a ring, the remote site compares the received number of the cell-phone with a stored version thereof and, if equal, approves the person's identity.

In this second configuration, several additional measures are contemplated by the invention for increasing the reliability of the identification, in face of the possibility of malicious tampering and for securing the remote site from unauthorized access. One such measure is for the remote site to randomly select the telephone number, to be dialed, from among several possible ones and to send it garbled according to a code unique to the person; the program at the local computer de-garbles the number before feeding it to the cell-phone. The invention contemplates a special software or hardware component at the remote site, to manage the allocation of telephone numbers and the verification of received cellular calls. Other measures call for the de-garbling to be carried out by the adapter, which has the code etched within and, alternatively, for periodic changes of the code or for manual complementary entries. A further measure is to obtain from the cellular system the current location of the dialing cell-phone and to compare it with known data about the legitimate location of the person. The additional security measures mentioned above, with respect to the first configuration, are also applicable here. For even further security, the identification method disclosed herein may be combined with conventional identification means, such as passwords and biometric measures.

A particular application of the second configuration is the individualization of data packages downloaded from the remote site to a person's computer especially if the data package represents intellectual property, such as software, a musical piece or a video title. In order to receive such a data package, the person is required to identify himself, through the cell-phone; the identity of the person is then inserted into the data before downloading and serves to eventually detect unauthorized copies.

A third configuration involves the person's computer and two remote sites and aims primarily at securing financial transactions. Most typical of such a relationship is that of a credit-card purchase over the Internet. Here, the person communicates through his computer with a merchant's World-Wide-Web site regarding the purchase of some merchandise or service. According to this configuration of the invention, the financial transaction is carried out through a third party, namely a site or an agent of the credit-card company. Accordingly, the credit card number is not conveyed to the merchant and, in fact, is not conveyed over the Internet at all. Rather, the merchant sends certain data regarding the purchase to the computer of the person (the purchaser), which conveys it to the credit-card site, together with the person's name; thereupon it is given a telephone number for the cell-phone to dial and upon reception of this call, the credit-card site is able to authenticate the identity of the person (in a manner similar to that described above, with respect to the second configuration). The conveyed information is stored in a “safe” and subsequently retrieved and compared with corresponding data received directly from the merchant site. When all the data match and the usual credit approval is obtained, the transaction is finalized and both parties are notified. Clearly, suitable SW must be resident in all three sites. In addition, the invention contemplates a software or hardware mechanism at the credit-card site to serve as the safe, such that guards the information therein from unauthorized access or tampering.

An additional function within the credit-card transaction application is the authentication of the vendor site to the purchaser, which is useful in the case of a small generally unknown vendor. For this function, the configuration is modified to enable the vendor to identify itself to the credit-card site, using the vendor's cell-phone. While the vendor site transfers the transaction data, its cell-phone is made to dial a number provided to him and the received cell-phone ID is compared with a registered version at the credit-card site; a certification is then conveyed to the purchaser together with the transaction verification.

Another application for the third configuration is for one remote site to serve as an identity authenticating agency for other remote sites. This has value for a small site that wishes to limit access to it to identifiable persons, but cannot afford to acquire and maintain the capabilities stipulated in the second configuration. Such a site would subscribe to the authenticating agency and would refer to it any person seeking access; he would identify himself to the agency, using his cell-phone, connected to his computer, in the manner described above with respect to the second configuration; the agency would then certify the identity of the referred person.

A fourth configuration involves the computers of two separate persons or parties and a remotely accessible site, to whom one or both parties must identify themselves. This configuration serves primarily to authenticate a document or a digital signature, whereby the remote site belongs to an authoritative agency, i.e. a mediator, who, in effect, acts like a notary. A typical procedure, according to the invention, is for each party to identify itself to the mediator site, in conjunction with the document, by means of the cell-phone (in a manner similar to that explained above, with respect to the second configuration); the mediator then certifies to each party the authenticity of the other party. Again, suitable SW must be resident in all three sites. Clearly, this procedure may be extended to include three or more parties and need not necessarily be symmetrical. Any of the additional safeguards mentioned above is applicable to this configuration as well.

Another application of the fourth configuration is the authentication of electronic mail (e-mail), so as to help the receiver avoid unwanted messages, including malicious messages sent by proxy through the receiver's correspondents. In this application, typically a mail server acts as a mediator. The sender of an e-mail message identifies himself to the mail server, by means of the cell-phone as explained above; the mail server then certifies to the receiver (or multiple receivers) the identity of the sender. Suitable software is required at the sender's and the mail-server sites.

It should be understood that the situations and applications described above are only exemplary and that many more are possible, to which any of the configurations of the invention is applicable. Furthermore, other configurations utilizing the basic principles of the invention are possible, and it is likely that some new ones will be thought of in light of the availability of the method.

It should further be understood that at least some of the configurations and applications described above can be realized also using means of identification other than the cell-phone-based means disclosed herein, although the latter is deemed preferable, and that therefore the procedures described above to carry out such applications are by themselves part of the invention, regardless of the means of identification utilized. The methods and systems of the invention thus additionally serve to provide security to a large variety of transactions carried out over computer systems and wide-area networks.

Specifically, the invention provides a method for verifying the identity of a person seeking to gain access to a local computer, to any computer communicative therewith or to any facility accessible through any of these computers, the method comprising:

(i) Providing a cellular telephone, to be termed cell-phone, associated with a cellular network and registered to the person or legitimately in the person's possession, the cell-phone having at least one reference number stored therein;

(ii) Providing a direct communication link between the cell-phone and the local computer, the link possibly including an adapter;

(iii) Storing in any of the computers copies of one or more reference numbers stored in the cell-phone; and

(iv) Reading any of the reference numbers stored in the cell-phone, comparing it with the corresponding one of the stored numbers and accordingly verifying the identity of the person.

In an expanded configuration, the method of invention further comprises:

(v) providing a telephone connection between the local computer and a dial-up network, the connection being associated with a dialing number;

wherein step (iv) includes:

(a) sending a signal from the local computer to the cell-phone that causes the cell-phone to initiate a call to the dialing number, thereby causing at least one reference number stored in the cell-phone to be read out and transmitted over the cellular system;

(b) Receiving a call over the telephone connection and extracting from the received call any transmitted reference number.

In another configuration, the method of invention aims at verifying the identity of a person seeking to gain access through a local computer to any remote computer communicative therewith through a network, or to any facility accessible through the remote computer, the remote computer being termed a target computer and further comprises:

(vi) providing one or more telephone connections between any remote computer and a dial-up telephone network, the remote computer being termed a response computer, the response computer being communicative with the local computer through the network and being communicative, or identical, with the target computer, and each of the telephone connections being associated with a dialing number; and

(vii) transmitting one or more numbers, corresponding to the dialing numbers, to the local computer;

wherein in step (iii) the storing includes storing in the response computer and step (iv) includes:

(c) sending a signal from the local computer to the cell-phone that causes the cell-phone to dial any of the dialing numbers of step (x), this operation initiating a call and causing at least one reference number stored in the cell-phone to be read and transmitted over the cellular system; and

(d) the response computer receiving the call initiated in substep (d) and extracting therefrom any transmitted reference number.

Many variations of the method, suitable for specific network configurations and types of facilities offered for access, are possible, some of them being discussed in the description to follow and specifically claimed.

In another aspect of the invention there is provided a method for verifying the identity of a person seeking to gain access through a local computer to any remote computer communicative therewith through a network, or to any facility accessible through the remote computer, the method comprising:

(i) Providing a cellular telephone, to be termed cell-phone, associated with a dial-up cellular network and registered to the person or legitimately in the person's possession, the cell-phone having at least one reference number stored therein;

(ii) Providing a direct communication link between the cell-phone and the local computer;

(iii) providing at any remote computer one or more dial-up telephone connections, the remote computer being termed a response computer, the response computer being communicative with the local computer through the network;

(iv) Storing in the response computer copies of one or more reference numbers stored in the cell-phone;

(v) causing the local computer to command the cell-phone, through the link; to initiate a call to any of the telephone connections and to thereby cause at least one reference number stored in the cell-phone to be read out and transmitted;

(vi) the response computer receiving the call initiated in step (v) and extracting therefrom any transmitted reference numbers; and

(vii) comparing any reference number extracted in step (vi) with the corresponding one of the stored numbers and accordingly verifying the identity of the person.

The variations of the method, mentioned above, including those discussed in the description to follow and specifically claimed, are applicable also to this last aspect of the invention.

The invention also provides computer configurations and components that carry out all or part of the steps of the disclosed method.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram of a first configuration of a preferred embodiment of the invention

FIG. 2 is a block diagram of a second configuration of a preferred embodiment of the invention

FIG. 3 is a block diagram of a third configuration of a preferred embodiment of the invention

FIG. 4 is a flow diagram illustrating operation of the configuration of FIG. 1.

FIG. 5 is a flow diagram illustrating operation of the configuration of FIG. 2.

FIG. 6 is a flow diagram illustrating operation of the configuration of FIG. 3.

FIG. 7 is a flow diagram illustrating operation of a modified version of the configuration of FIG. 3.

FIG. 8 is a flow diagram illustrating operation of another modified version of the configuration of FIG. 3.

FIG. 9 is a flow diagram illustrating operation of a modified version of the configuration of FIG. 3.

### DETAILED DESCRIPTION OF THE INVENTION

The preferred embodiments of the invention will now be described with respect to a number of configurations that include various combinations of the features of the invention and are applicable under a variety of circumstances and for a variety of purposes. All these are disclosed here by way of example and are not to be construes as restrictive or exclusive.

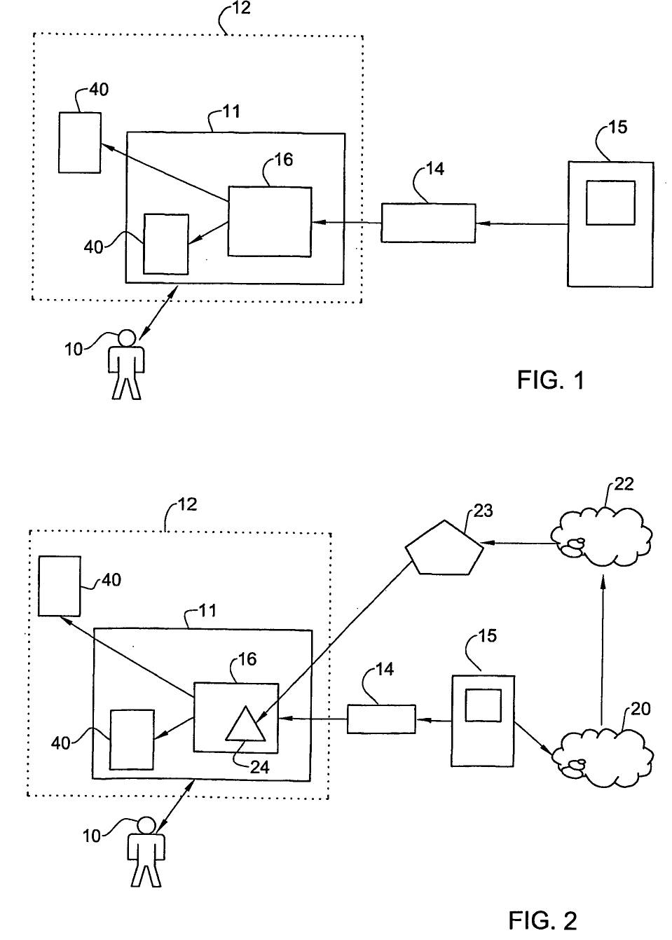

A first configuration, depicted in the block diagram of FIG. 1, aims primarily at verifying, or authenticating, the identity of the person 10 that is seeking access to the computer 11 with which he is currently interacting, to be referred to as the local computer, or to any other computer (not shown) communicating with the local computer directly or over a network, to be collectively referred to as the local computer system 12 or, briefly, the local system, as well as to any facility 40 provided by any of these computers. The term facility is used throughout this specification to indicate a group of data stored in the respective computer or available through it, the operation of a software program or application or any other service available by interacting with the respective computer or computer system. The term “computer” should be construed throughout this specification to include a stationary computer (which includes a conventional desktop- or deskside computer, a work-station and a so-called server), a portable (e.g. laptop) computer and any digital processing device or system having the necessary functionality and connectivity; such a device may even be one whose primary function is not computing, such as, for example, a television set, a domestic or industrial appliance, vending apparatus, a cash register, a personal digital assistant (PDA), etc. For convenience, the term “computer system” will be used to denote any computer or group of computers that are interconnected—directly or by a local network. In general, verifying or authenticating the identity of the person may involve also other means, such as passwords and biometric sensing. The methods and means disclosed herein may be used in place of, or in addition to, any such other means. In addition to verifying the identity of the person, there may be further requirements and criteria involved in a decision to grant the requested access to the computer or the facility. The methods and means disclosed herein are not meant to replace or preclude the consideration of such requirements and criteria.

In the configuration of FIG. 1, the local computer 11 is in direct communication with a cellular telephone 15, to be referred to henceforth as cell-phone, for short. The term cell-phone throughout this specification should be construed to include any device capable of communicating directly with a suitable radio communication system, and having an individual identification code stored within, by which code, referred to as the cellular calling number, it is known to the system; the device must also have local connectivity, e.g. an electrical port or any other means, e.g. optical or radio, for communicating with a nearby device or computer. Beside conventional cellular telephones, such devices may include, for example, pagers and beepers, common-channel (or direct-communication) radio devices and personal digital assistants (PDA) with radio communication capability. Preferably the corresponding communication system has switching (dial-up) capabilities or is communicative with a switching (dial-up) telephone network. Preferably cell-phone 15 has also a device identification code permanently stored within, which is universally unique. Preferably the cell-phone has also additional digital storage, such as that used to store directory information, messages and other data. The advantages of the use of a cell-phone in the present context have been presented in the Summary hereabove. It is assumed that every person seeking access through the method of the invention has a cell-phone in his possession, which is registered—either directly to him or to a person or organization from whom he has obtained a legitimate permission to use it.

Direct communication between cell-phone 15 and local computer 11 is carried by a direct, i.e. point-to-point, communication link. This link may be, as a whole or in part, in the form of electrical connection or any wireless means known in the art, such as a sonic link, magnetic coupling, a light beam or any other electromagnetic radiation. The communication between the cell-phone and the computer may be immediate, e.g. by direct connection or through a single two-way electromagnetic link, if their respective interfaces match both physically and logically (i.e. in terms of signal format). However, in general, the communication is through a suitable adapter 14. Suitable adapters, usually with electrical connections, are commercially available and conventionally serve to enable a computer to send and receive data over a cellular network through the cell-phone. Although in systems incorporating the present invention such conventional function of adapter 14 may be retained, its function according to the invention is different, as will be explained below. Adapter 14 is connected to, or communicates with, local computer 11, on the one hand, and with cell-phone 15, on the other hand. The mode of connection to, or communication with, the cell-phone or the local computer may be an electrical cable or some wireless means, such as outlined above. According to advanced features of the invention, to be described below, Adapter 14 may have additional components or capabilities, not found in conventional or commercially available devices, and would then be part of the invention. A cell-phone in direct communication with the computer, as described above, will be refrred to as a linked cell-phone.

An access identification program module (AIM) 16 according to the invention is resident or stored in the local computer or system. It is capable of communicating with any linked cell-phone, possibly through the adapter. The AIM is also capable of communicating with any access control program (not shown) already resident in the computer system appropriate to the type of access sought, which affects the actual access. The AIM, in effect, parallels, and preferably supplements, the function of other identification facilities, such as password checking or more sophisticated personal identification methods, including those based on biometric sensing. The access control program is usually part of a security module (or -system) resident in computer 11 or computer system 12, and will henceforth be referred to as the security module.

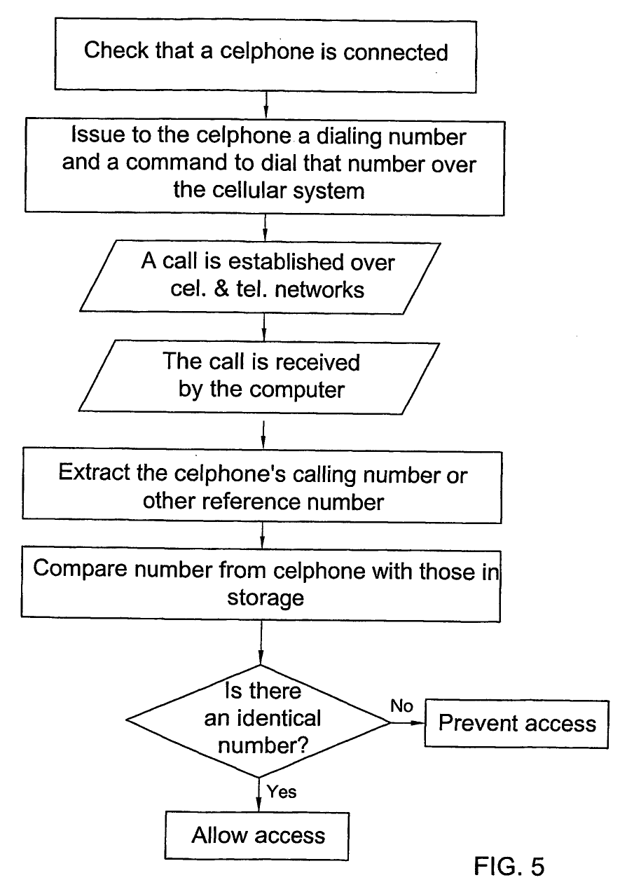

Typical operation of the configuration of FIG. 1, illustrated by the flow chart of FIG. 4, is basically as follows: Initially, a copy of the call number of each cell-phone associated with a person, having privileges to access the computer system or any specific component or facility 40 therein, is stored in local computer 11 or in local computer system 12, together with the person's name and other personal data (such as passwords) and with the names of the specific components and facilities for which the person has access privileges. Whenever the person wishes to access the system, the component or the facility, he connects his cell-phone to the local computer, as provided for, or else is reminded to do so. The AIM 16 then sends a signal to the linked cell-phone 15, possibly through adapter 14, that causes the call number of the cell-phone to be read out and transmitted back to the computer system. AIM 16 then compares the received call number with the stored ones and, if a match is found, it reads the corresponding permission data. If the latter data match the type of access (e.g. component or facility) sought, a positive indication is conveyed to the security module of the computer system; else a negative indication is conveyed. It is noted that, except for the act of connecting the cell-phone (which need be done only once per session) the operation is automatic, not requiring the person's intervention.

In order to provide higher security, for the case that a computer user fraudulently takes on the identity of someone having access privileges and stores in his own cell-phone that person's call number, the method optionally includes the capability of reading out from the linked cell-phone also the hardware identification number permanently stored therein. The operation is modified to store also copies of the hardware numbers of the persons with access privileges and to compare these with the readout hardware number.

Another option for additional security is to store in the computer and to read out from the data memory of the linked cell-phone a particular number or word stored therein. This is aimed at the possibility that the hardware number is not easily read out or that an impostor would falsify a cell-phone, by writing into it also the hardware number of the access-privileged user. Since the user may store in the data memory numbers or words known only to himself, the impostor will not be able to mimic them in his cell-phone.

The three types of numbers readable from the cell-phone, as described above or as will be described below, will be referred to collectively as reference numbers.

Another group of optional security measures that the invention contemplates are associated with the adapter and are aimed at the case that an impostor may be illegitimately in possession of a cell-phone that belongs to a person with access privileges; this may, for example, be by way of theft or just by using the cell-phone when left unsupervised. These security measures individualize the adapter; such an adapter is novel and therefore part of the invention.

One of these optional measures is to permanently store in adapter 14 a code number. The same number is stored in computer 11, possibly along with code numbers of other adapters. When access is requested, AIM 16 reads the code number from the adapter and compares it with the stored ones and only when a match is established does it permit to proceed with the identity verification process. Optionally the stored code number is encrypted and the AIM decrypts it before comparing. This measure is aimed at preventing an impostor from providing his own individualized adapter.

Another measure is a locked switch built into adapter 14, which enables the transmission of the required data between the computer and the cell-phone only when unlocked. Unlocking may be by means of any of a variety of techniques known in the art, such as, but not limited to, a mechanical key, an electrical keypad (with a key code), a coded card, a biometric sensor or any magnetic or electromagnetic device, whether with an energetically active or passive key component.

Yet another measure is to provide adapter 14 with an encryption module, capable of encrypting data read from the cell-phone to the computer. In this case it is the encrypted version of any cell-phone reference number that is stored in the computer. The AIM reads a reference number from the cell-phone as encrypted by the adapter and compares it with the version stored in the computer.

It is noted that the measures described above with respect to the adapter are not meant to serve by themselves in identifying the person, as is known in the art, but merely as additional security while applying the primary means of identification according to the invention, namely the communication with the linked cell-phone.

An additional optional security measure is designed to prevent an impostor from accessing the computer system remotely, say from any computer other than local computer 11, while a cell-phone is legitimately connected to the local computer. To this end, the invention calls for a guard module that monitors the data flowing into the cell-phone and if it is a command for reading a reference number therefrom, it is compared to any such command actually issued from the AIM. If no match is found, a warning is issued. The warning may be in any suitable form, including a sound, a flashing light, a message on the display screen or signaling the system's security module or any other agent.

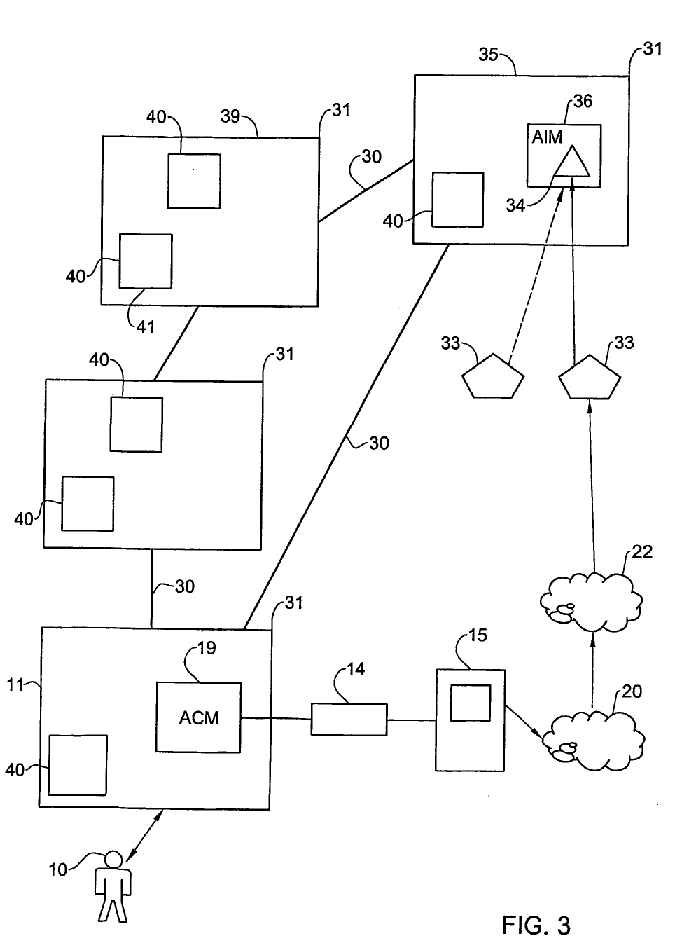

FIG. 2 shows another configuration of the invention, which is an expanded version of the configuration of FIG. 1 and differs from it in its mode of operation. This configuration is designed to offer a higher level of security, by using the unique properties of cell-phones (as discussed above) to their fullest. The additional components involved here are:

the cellular communication system 20, with which cell-phone 15 is in communication,

a regular switched (dial-up) public telephone network 22, which is communicative with the cellular system 20,

one or more external telephone line connections 23 from computer 11 to telephone network 22 and

a call handling module (CHM) 24, within AIM 16 or communicative therewith, which is a controller that monitors calls arriving at telephone connections 23. Optionally, some or all of line connections 23 are cell-phones, communicative with a cellular system, possibly the same as system 20, in which case that cellular system assumes the role of the switched telephone network 22. The term line connection herein should therefore be construed as including such cellular communication means. Each line connection 23 is associated with a dialing number, by which a call through telephone network 22 is directed to it. It is noted that switched telephone network 22 may be embodied, wholly or partly, in any form and by any means known in the art, including the use of digital networks, possibly also a network that serves to connect the computers (if plural) under discussion. The only required characteristic is that any line connection 23 be dialable from cell-phone 15, whereby communication therebetween is established. It is also noted that none of the above components, except CHM 24, are required solely for the purpose of identity verification according to the invention; on the contrary, they usually are present anyway. CHM 24, on the other hand, is part of the invention and is implemented as a software program or a hardware component or a combination of the two and its function will be evident from the explanation of operation, to follow.

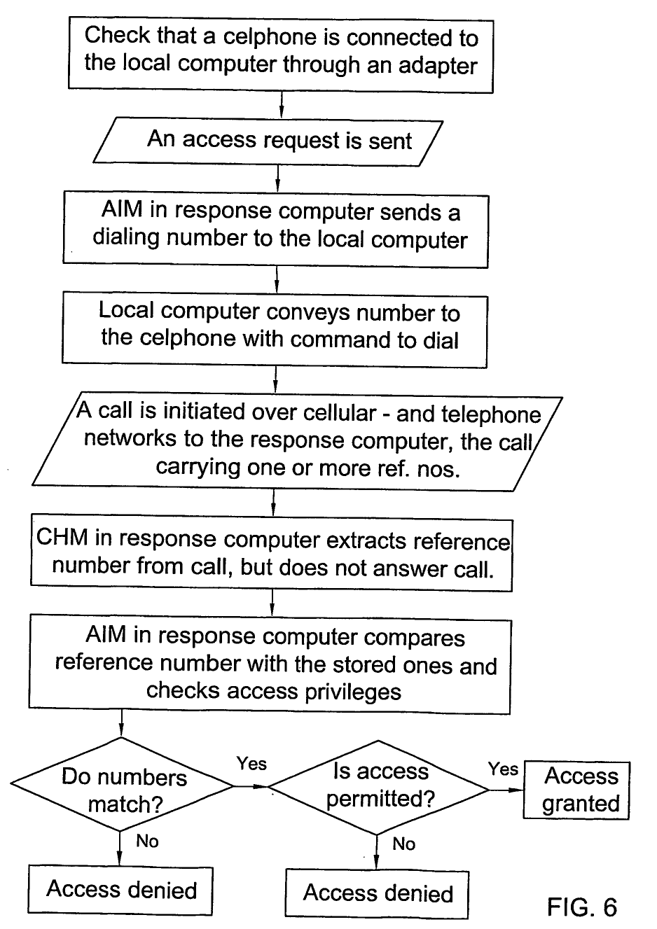

Basic operation of the configuration of FIG. 2, illustrated by the flow chart of FIG. 5, is similar to that of the configuration of FIG. 1 except as follows: The dialing numbers of one or more of the telephone connections are stored in the cell-phone; alternatively, they are stored in computer 11 and accessible to AIM 16. When an access is requested by user 10, there is sent to cell-phone 15 a command to dial one of the call numbers; in the alternative case, the number is conveyed to the cell-phone from the computer. As a result, cell-phone 15 initiates a call over cellular system 20, which call is routed over telephone network 22 to connection 23 of computer 11. CHM 24, which is capable of sensing and identifying the originating call number of any arriving call (which is equivalent to a caller identification function), monitors all calls arriving at the line connection 23 that corresponds to the dialed number over a certain period of time following the issuance of the aforementioned command by the AIM. CHM 24 then checks whether the originating number of any incoming call matches the stored number of the cell-phone associated with the requesting user 10. It is noted that also this operation is automatic and may proceed unknownst to the user.

A particular feature of the method is that the originating call number may be extracted by the CHM from the incoming call prior to answering the call. Possibly also other reference numbers sent from the cell-phone may thus be extracted. The call need not, therefore, be answered and thus the call will normally not be charged to the subscriber (e.g. owner of the cell-phone).

Any of the additional security measures described above for the configuration of FIG. 1 can also be applied to that of FIG. 2. Thus, for example, additional reference numbers, including the hardware identification number, may be made to be read out from the cell-phone and conveyed with the call, then extracted by the CHM and compared with stored versions thereof. Optionally, some of the reference numbers may be read out from the cell-phone and conveyed directly to the computer, as in the configuration of FIG. 1. Likewise, the security measures associated with adapter 14 may also be used in this configuration. The locked switch would then, for example, control the transmittal of the dialing command from the computer to the cell-phone, whereas the encryption module may work in reverse—decrypting a previously encrypted dialing number while conveying it to the cell-phone for dialing.

An additional possible security measure, aimed at overcoming the possibility of an unauthorized person accessing the computer by using legitimate cell-phone and adapter already connected (and possibly left unsupervised), is to require that the user key in one or more digits or letters in order to enable the described verification process. These digits may, for example, be part of the dialing number or part of the code stored in adapter. The keying may be at the computer's keyboard or at the keypad of the cell-phone, as necessary.

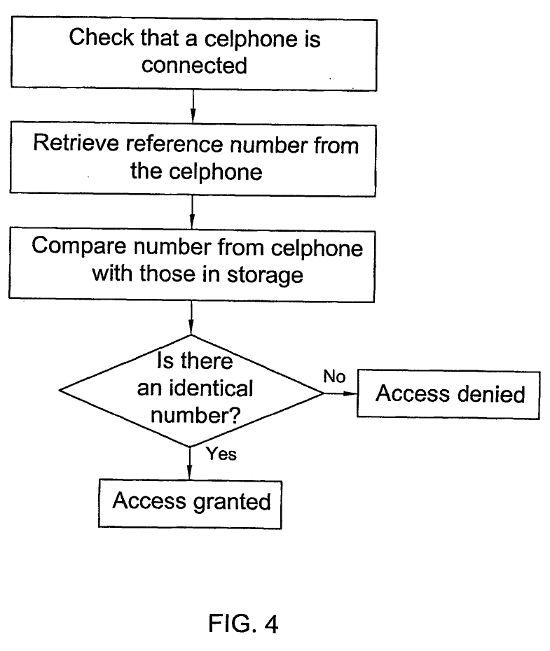

FIG. 3 depicts another configuration of the invention, which is a further expanded version of that of FIG. 2. It is aimed at a plurality of computers 31 interconnected by a network 30, in which facilities 40 provided by any one of the computers are accessible to authorized users through any of the other computers. The computers and the network will be referred to collectively as the computer system. The network 30 may be of any type, including a local-area network (LAN) a wide-area-network (WAN) and a virtual private network (physically using a WAN, including a public WAN such as the Internet). For certain functions, the network itself may also be a public (open) WAN, such as the internet.

In this configuration, there is an AIM 36, which is normally resident in one of the computers of the network, in association with a CHM 34 (which may optionally reside in the same or another computer). The computer in which the CHM 34 resides will be referred to as the response computer 35. For the sake of explanation, an exemplary case is considered, in which the facility of interest 41 resides at, or is available through, a certain one of computers 31, to be referred to as the target computer 39, and the access to it is sought by a person 10 through his computer, to be referred to as the local computer 11. It should be understood that other computers in the system may each serve as a local computer 11 and also that other computers in the system may each serve as a target computer 39; for any one local computer, the target computer is considered to be remote. Also for the sake of explanation, the facility to which access is sought is assumed to be a data-base 41, with an associated data retrieval service. However, any other type of facility may be contemplated for access according to the invention, including, for example, overall access to the target computer, any software program therein, any file or document (or a group of file or document) and any service provided. Some specific facilities are discussed further below. In certain cases, or for certain types of facilities, the target computer 39 may, or sometimes must, be identical to the response computer 35; in certain others, they must be distinct.

Similarly to the configuration of FIG. 2, CHM 34 communicates with one or more external telephone line connections 33 in the response computer 35, and has the capabilities outlined above. Some or all of telephone line connections 33 may be dedicated to the access permission functionality or they may also serve for regular telephone functions. In the latter case they are likely to be part of a private telephone exchange (PBX—not shown); CHM 34 is then preferably designed to cooperate with the PBX. In response computer 35 are stored the reference numbers of all cell-phones in the possession of persons holding access privileges to facilities in the system, together with corresponding permission details (such as the particular computer or facility accessible and the level of permission) and other identification data. Each local computer 11 is connectable to a cell-phone 15, possibly through an adapter 14, and there is resident in it a special program module, to be referred to as access communication module (ACM) 19, whose function will be evident from the explanation of operation, to follow.

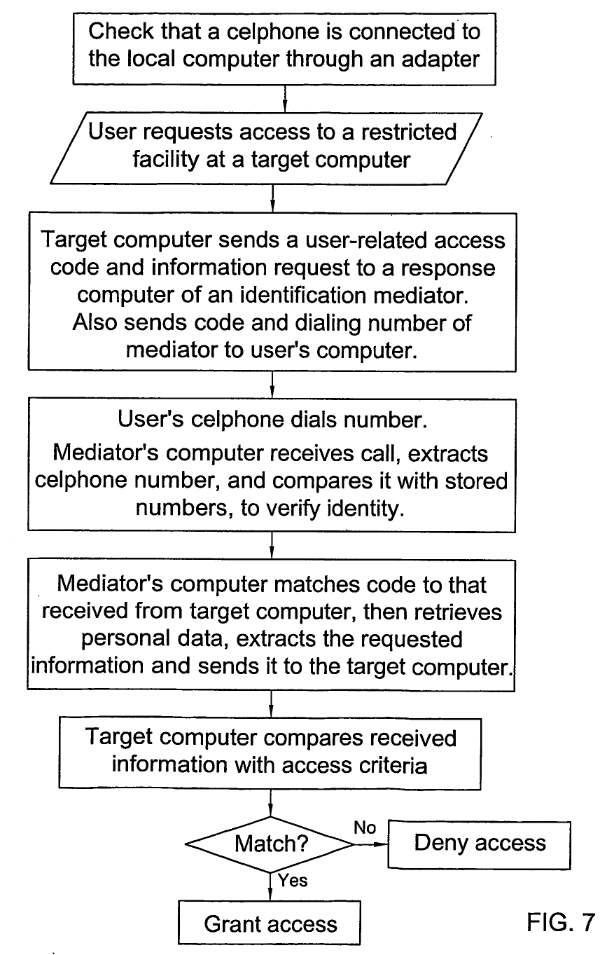

Operation of the configuration of FIG. 3, illustrated by the flow chart of FIG. 6, is, in many respects, similar to that of FIG. 2, except as follows: The dialing numbers of all the telephone connections are stored in response computer 35 and are accessible to AIM 36. The access request of person 10, entered at local computer 11, is conveyed, over the network, to AIM 36, which consequently retrieves a dialing number and sends it, over the network, to local computer 11. There, ACM 19 conveys the dialing number to any linked cell-phone 15, along with the dialing command, which initiates a process similar to that of the configuration of FIG. 2. The resulting call, transmitted through cellular system 20 and telephone network 22, and arriving at a corresponding telephone connection 33 of response computer 35, is monitored by CHM 34, which extracts the originating call number of cell-phone 15 (and/or any other reference number optionally carried by the call) and submits it to AIM 36 for comparison with the stored reference numbers. In the case of a match, a corresponding indication of access permission is sent, over the network, to target computer 39 or to a central access control facility of the system, if present; a corroboration is also sent to local computer 11, which notifies the person.

It is noted that the method described above with respect to FIG. 3 can be carried out in addition to the methods described with respect to FIGS. 1 and/or 2. Also, any of the security measures applicable to the configuration of FIG. 2 is also applicable here with respect to the local computer and any cell-phone connectable thereto, including the measures associated with the adapter. It is further noted that the telephone call received by the response computer need not be answered, since the cellular reference numbers can be extracted before sending an answering signal. Also to be noted is that the entire process is, again, wholly automatic—being preferably hidden from the user (except for the final outcome of access approval or disapproval).

Additional optional security measures contemplated by the invention with respect to the configuration of FIG. 3 are as follows:

The process of sending a dialing number, dialing it from the cell-phone and checking the reference number in the received call is repeated periodically. This is aimed at the possibility that an intruder, operating over the network, will cut in on the access to the facility, before the original user has logged off, and will then stay illegitimately connected to the facility. At the next repetition of the process, such an intruder will be detected and disconnected.

In many cases, a person having access privileges is expected to seek the access from a particular computer at a particular location, or from a finite number of locations. Such locations may be stored in the response computer, as part of the person's identification data. Upon the receipt of an access request from such a person, his current geographic location will be sensed (by means explained below) then received by the AIM and compared with the stored locations; only upon a match will permission be granted. This security measure will prevent an impostor with a stolen or falsified cell-phone from successfully seeking access through another local computer. One convenient means of sensing the location of the cell-phone is often provided by the cellular network. At least the cell in which the cell-phone is located is known and some cellular systems have capabilities of establishing the location within a cell to some degree of accuracy. This location information should be obtainable by the AIM from the network. Another well known and highly accurate means for sensing the location is a satellite based geographic positioning system (such as the GPS system). To this end, the cell-phone will be equipped with a suitable sensor and will be operative to send the sensed location over the dialed call. A third means may be provided by installing at any relevant location (i.e. near a local computer from which access is expected to be sought) one or more cellular signal detectors, having limited reception range but capable of identifying the call number of an active cell-phone These would be connected to the local computer and, upon command, the number would be read into the computer then sent over the digital network, or over the cellular network, as part of the dialed call, to the response computer; its reception would attest to the presence of the cell-phone at the proper location. It is noted that all these means are known in the art, however their use, as well as the use of any other means of location sensing, for increasing the reliability of access related identification, as described above, is part of the invention.

Another optional measure for increased security, according to the invention, is to have a relatively large number of telephone line connections at the response computer and to program the CHM to select a different line, i.e. a different dialing number, for each successive request. Preferably the selection is according to some random process. This measure would hinder an impostor with a stolen or falsified cell-phone from successfully seeking access by eavesdropping on the transmitted dialing number and then dialing it by himself. This measure can be further strengthened by any of the following additional optional measures, or any combination thereof:

(a) The ACM at the local computer is programmed not to display the received dialing number and, moreover, to prevent this number from being retrieved by a user of this or any other computer.

(b) The dialing number is Transmitted to the local computer over the cellular network and the cell-phone, rather than over the digital network.

(c) The dialing number is encrypted before being transmitted; preferably the encryption key is individual to each user with access privileges. Upon reception by the local computer, the number is decrypted. The decryption may take place either in the local computer, as part of the ACM functionality, or within the adapter or within the cell-phone—the choice depending on the technical capabilities of the various devices and on the specific violation risks most expected.

Preferably the AIM cooperates with any conventional access control module, or facility, that may exist in, or is planned for, the computer system. Such cooperation may, for example, amount to having the AIM corroborate to the access control module the identity of the person who also identifies himself by other means, such as passwords, magnetic identification cards, and biometric sensing means (e.g. graphic signature verification, voice recognition and fingerprint- or iris identification). It is noted, however, that the method of the invention offers by itself a relatively inexpensive, yet highly secure, means of identification and may thus obviate the need for some or all of the other means, especially the relatively expensive biometric sensing means.

Particular constraints, requirements, modifications and application possibilities are associated with the configuration of FIG. 3 when the network is an open (e.g. public) network, such as the Internet. Some of these will be discussed below. All such open networks will herein be referred to by the term Internet, for brevity. In many cases it is required that the target computer be identical with the response computer or that they be connected between them by a closed network or a secure link (which may, though, be realized over the open network). In many other cases, the target computer and the response computer are assumed to be distinct; in many of these cases the response computer serves as a mediator. Typical facilities that need access permission, provided on any network by target computers, include data-base management systems, prepaid services of various sorts, including the provision of information and the remote use of software programs, and downloading of intellectual property, such as music, pictures and software. Additional typical facilities provided particularly over the Internet include:

Accessing, and possibly managing, a personal account held at a financial, medical or governmental institution;

Using some service on the basis of subscription, especially if it involves a fee,

which would be pre-paid; and participation in a chat group or any type of a club.

Sometimes the very access to the target computer itself is a highly guarded facility, designed to keep out spies and saboteurs, inter alia. For all of these facilities the target computer and response computer are preferably identical or tightly connected. However in certain situations, a looser connection between them may suffice; a mediating response computer may then provide a user-identification service to various target computers, using the methods of the invention. Users seeking access privileges to any of these target computers would then subscribe to the mediating response computer, which will store their identification data.

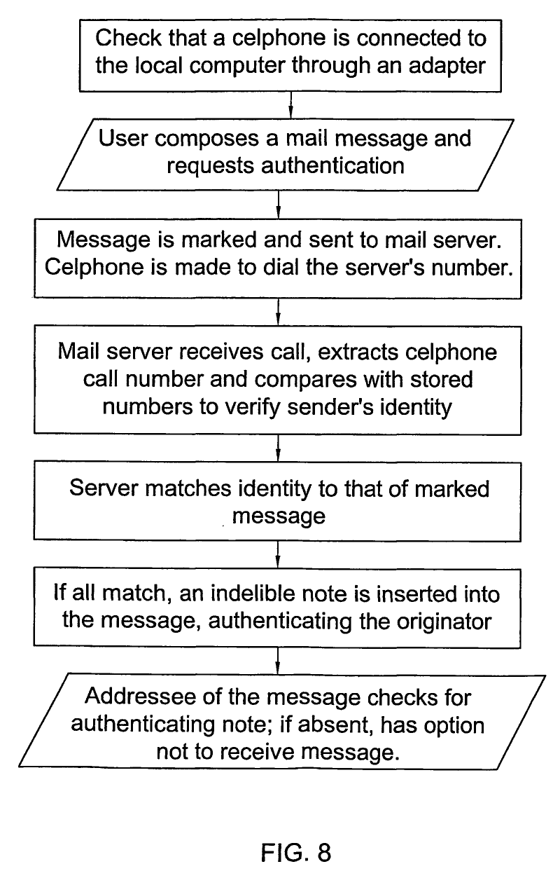

A particular type of a mediating user-identification service is one that provides to a target computer relevant data about a person seeking access to it. Such data may include the person's age, gander, educational level, etc. and would correspond to criteria set by the target computer as conditions for permitting access to a certain facility. In this manner the facility me remain open to anonymous visitors, as long as they meet the criteria, rather than be restricted to known pre-registered subscribers. Operation of such a facility, illustrated by the flow chart of FIG. 7, is as follows: When a person seeks access to a restricted facility at the target computer, he is asked for an identifying password and is given a dialing number, which corresponds to a telephone connection of the response computer at the mediator site. At the same time, the target computer sends to the response computer the password and a request for information, detailing the required personal data items. The user's computer conveys the dialing number to the linked cell-phone, which consequently dials it. The response computer extracts the cellular number from the received call, as explained hereabove, and compares it with the stored ones. When finding a match, the personal data stored in association with the number are received. These include the identification password. The latter is matched with the one received from the target computer and then the requested information is extracted and sent to the target computer. There the information is compared with the access criteria—to determine whether to grant access to the requesting person.

Another service that can be provided by a mediating response computer is the facilitation and approval of credit-account transactions between a computer user, as a buyer, and a vendor (of merchandise or services). This is a highly important service for business conducted over the Internet, whether retail, wholesale or business-to-business. The response computer would normally be associated with an organization that manages a credit-card system or with an authorized agent thereof (to be referred to as the service provider) and is preferably directly connected with their computer system and data bases. Typically, the response computer is equipped and operative similarly to that of the configuration of FIG. 3. Any person (or organization) who wishes to avail himself of the service in completing a transaction that he conducts with a vendor over the Internet is assumed to have an account with the service provider and to possess a cell-phone; he will be required to connect the cell-phone to his computer—possibly through an adapter, which he will have to acquire. For the purpose of retail transactions, as most users will conduct, the degree of security required is not very high and therefore a standard adapter, which is very inexpensive, may suffice. The user need also install in his computer (which in the present context is regarded as a local computer) an ACM software package, which he would probably download from the response computer; this need be done only once. The service provider would also have established connections, as it does conventionally, with various vendors; these would be either by some secure communication over the Internet or via some other data link. The server of a participating vendor, which is a node on the Internet, will be regarded in the present context as a target computer.

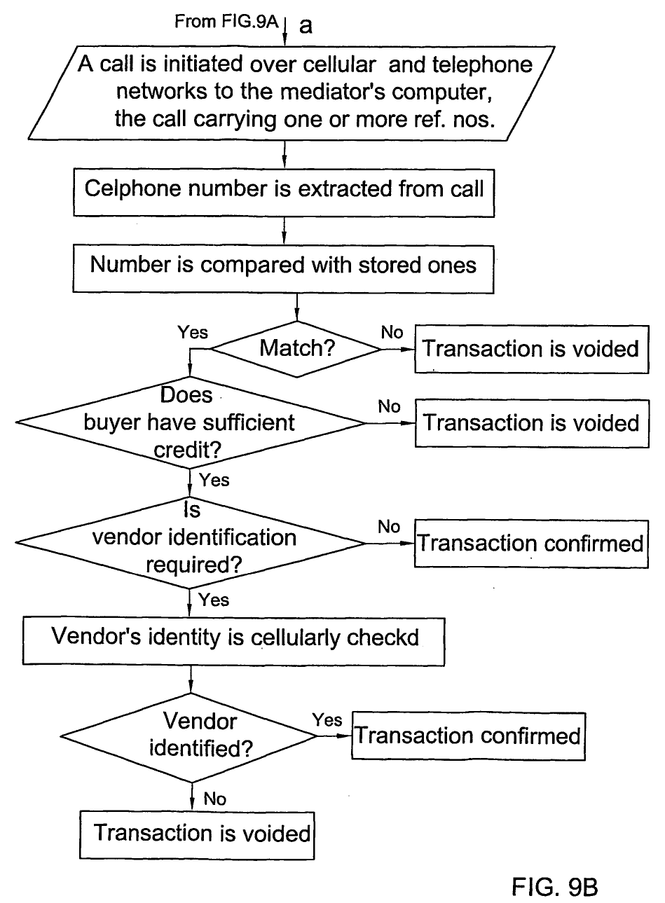

Typical operation, illustrated by the flow chart of FIG. 9, would then proceed as follows:

(a) The user negotiates from his local computer a transaction with the target computer, i.e. the vendor's server, over the Internet, as usual. He does not need to identify himself (except for a shipping address) and certainly need not disclose his credit account number.

(b) The user obtains from the vendor a transaction identification code and the amount of payment. The vendor sends the same data also to the service provider.

(c) The user contacts the response computer of the service provider over the Internet and identifies himself; the identity is verified by the response computer, using any method of the invention, as described above. Here, again, the credit account number need not be sent, but will be retrieved at the response computer, where it has been stored in association with the user's identity.

(d) The user sends to the response computer the transaction identification code and the amount. This will likely be by means of a displayed form.

(e) The response computer matches and compares the data thus received from the user and from the vendor. It also obtains pertinent credit data from the data base of the service provider and accordingly approves (or disapproves) the payment.

(f) Finally the response computer sends to the vendor a verdict of approval (or denial), which clinches the transaction. It also notifies the user.

For a higher degree of security, there is optionally provided a secure limited-access storage space in the response computer of the service provider. This storage space, with provision of a compartment for each transaction, is herein termed “cellular safe”. During the communication between the user and the service provider (step d above), all data communicated, including all identification data, are stored in a corresponding compartment of the cellular safe and retained as an archival record. It is available for possible future checking of the transaction, in case of questioning by any party. Further optionally, for even higher security, the user's local computer is instructed to send the transaction data also over the cell-phone and the telephone network—to be compared with the other received data and to be stored in the cellular safe. Further optionally, for very large transactions, the user is asked to confirm the transaction orally through the cell-phone; a digital version of the transmitted voice is then also stored in the cellular safe, along with the other data.

Another situation requiring the approval of credit-account transactions, in which the method of the invention can be useful, is the conventional situation of a customer buying merchandise or a service at a place of business. Usually the customer would present a credit card, which would then be read by a device that is in communication with a suitable approving agency. Alternatively, the number of the credit card, sometimes obtained orally from the customer, would be keyed into a device communicative with the agency or would be transmitted to the agency orally over the telephone. In any of these situations there is a risk that the credit card has been stolen or falsified or that the number given by the customer is false. In order to mitigate this risk, an independent identification of the customer may be required—which can be provided, according to the invention, by any of the methods (a-c) to follow. It is assumed that the approving agency has a computer, communicative with the necessary data-base. All these methods call for the customer to have a cell-phone and for the agency's computer to have the capabilities of a mediating response computer, as discussed above with respect to transaction approval over the Internet. Thus the response computer will have cellular reference numbers (possibly just the cellular call numbers) of credit account holders stored, in association with data related to the account holders (which would normally include the account number or other identifying information); The operation of the response computer for this purpose will also be similar to that described above with respect to credit account transaction approval. The methods differ from each other according to the situation at the place of business.

(a) If there is a computer at the place of business, which is in communication with the agency's computer, it will assume the role of a local computer in the configuration of FIG. 3 (whereby the target computer and the response computer will be identical or closely connected, both being associated with the agency, possibly serving also other functions). Typical operation is then as follows: After the normal communication with the agency, the customer is asked to connect his cell-phone to the adapter, connected to the local computer, (or the vendor's clerk may do it for him). A dialing, number, corresponding to a telephone connection of the agency and stored in the local computer or sent from the agency, is conveyed to the cell-phone and it consequently initiates a call, as described above. The agency's response computer receives the call and extracts the cellular reference number (e.g. call number) therefrom, then compares it with those in its storage, retrieves the matching entry and the associated data (e.g. the account number) to access data in the data base, required in deciding on the approval; inter alia, it compares the thus retrieved account number with that initially conveyed from the business. The decision would then be conveyed to the place of business. It is noted that the place of business may also be a vending is machine or a similar unattended vending facility that is capable of automatically accepting approval messages from the agency.

(b) If there is no suitable computer at the place of business, the procedure is similar to that of (a) above, except that the customer is asked to manually dial on his cell-phone a certain number, which corresponds to a telephone connection of the agency's response computer. The number is preferably obtained from the response computer, either by phone to the vendor or through the customer's cell-phone. In the latter case it may be in the form of a text message or as a call from the corresponding telephone line, which would not be answered by the customer but rather would leave the number in the cell-phone's memory to be dialed back.

(c) If the place of business is a vending machine without immediate communication with the agency, the method is similar to that of (b) above, except as follows: The machine is equipped with a keypad and with an internal registry device, under contractual arrangement with the credit account agency. The dialing number is posted on the machine; alternatively, the dialing number is displayed when a selection has been made by the customer. At the response computer, the extracted reference number is used to directly or indirectly retrieve the customer's account number, which solely serves to access the data-base for approval information. Optionally the customer is asked to also key in on his cell-phone a password, which is then retrieved by the response computer and compared with a version stored along with the customer's data. Upon approval, the response computer sends to the customer's cell-phone a unique transaction code. The customer then keys this code into the machine's keypad. This code number is registered in the registry, alongside the amount and type of purchase and the retrieval of the merchandise is enabled.

An additional service that a service provider may render, either in conjunction with the mediation of credit-account transactions, per above, or separately, is the authentication of the identity of a corporate entity associated with an Internet node (e.g. a Web site), such as a vendor. This is particularly important with respect to small, generally unknown, vendors, whom a buyer may not otherwise trust. In this case the methods of the invention would be similarly applied, but with the roles of the local computer (associated with the user/buyer) and the target computer (associated with the corporation/vendor) reversed: The vendor will have to connect a cell-phone belonging to the corporate entity to his server computer. The server computer will then receive from the response computer a dialing number, which the linked cell-phone will dial, and the AIM of the response computer will then verify the received reference number(s). This process may have to be repeated from time to time. Upon request, the user/buyer will receive from the response computer an authentication or corroboration of the identity of the vendor site.

Many more services are enabled by the identity verification methods of the invention. Some of these will be described in what follows, whereby one or another of the network configurations discussed above will be invoked, the identity verification process itself generally being similar to that of the configuration of FIG. 3.

Sometimes an Internet server is subject to malicious overload of contacts, referred to as a massive attack. For such an eventuality, the site may establish a register of legitimate clients, where their cellular reference numbers will be stored. In the case that a massive attack is detected, the access control module will automatically begin a mode of restricted access, during which only clients that identify themselves by means of the cellular verification methods of the invention will be granted access to the site. This will leave out all contact attempts caused by illegitimate processes through surrogate client sites.

Digital signatures are still not entirely relied on, for lack of secure means of authentication. Cellular identification according to the invention may appreciably contribute to verifying the authenticity of digital signatures on a document, using, for example, the following procedure: A response computer of a service provider receives a document from one client user, through his local computer and the network. The client is identified through his linked cell-phone, in the manner explained above. The response computer then inserts into the document, as an indelible field, the identity of the client, together with the cellular call number (or another reference number). If this is a contract, the document may then be sent to another party and the process is repeated with respect to that party as a client. This may be repeated for any additional signatories.

Another service that may be directly offered over the Internet by a service provider with a response computer according to the invention is attestation of document delivery. This is akin to a messenger service with return receipt. The procedure would be as follows: The response computer receives a document from an originator and sends it on to the local computer of the addressee, together with a dialing number. The addressee is assumed to have his cell-phone connected to his local computer, or will be asked to do so. His cell-phone will then automatically dial the received number, whereupon the response computer will match the extracted call number with a stored version—to verify the receivers identity. It will then issue a delivery-affirmation note and send it to the originator, possibly attached to, or inserted into, a copy of the document.

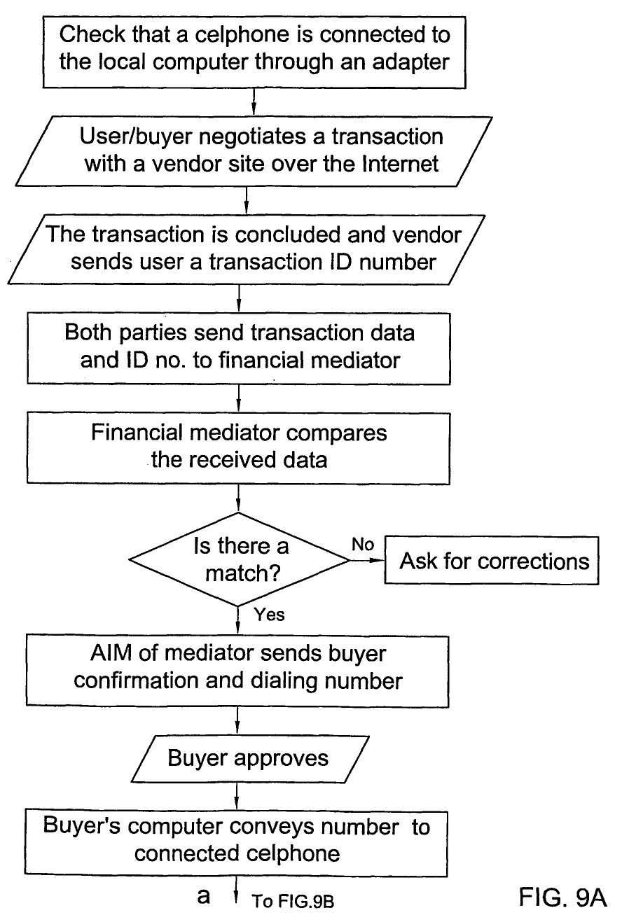

Electronic mail (e-mail) is in wide use over the Internet. Unfortunately it is often abused to spread viruses and other malicious contents. Often such malicious e-mail messages are spread by implanting automatic message sending instructions in unsuspecting surrogate computers. The method of the invention can be used to advantage in this area as follows: An e-mail server for sending messages (which, in the present context, may be regarded as a target computer for mail service) takes on also the functions of a response computer, as described above. A participating client of the mail server has an ACM installed in his local computer and has a provision for connecting his cell-phone thereto. As illustrated by the flow chart of FIG. 8, when sending an e-mail message that the client wishes to authenticate he will indicate so and then the mail server will initiate the process of cellular identification, whereby it sends to the local computer a dialing number, which is then dialed by the attached cell-phone; the response computer of the mail server receives the call and extracts the originating call number. This number is then compared with the stored records and if a match is found, an authentication mark is inserted into the mail message before it is sent on. According to an alternative procedure (actually used in the flow chart of FIG. 8), a dialing number of the response computer is stored in the local computer and when sending a message to be authenticated, this number is automatically dialed by the linked cell-phone. The mail server response computer then proceeds as described above.

As mentioned above, one of the types of facilities accessible over the Internet that usually require user identification is the downloading of intellectual property, such as music, pictures, video and software programs. Often this downloading carries a fee and it is in the interest of the provider that the property not be copied by the client and further distributed. When a client positively identifies himself to the provider, by means of the methods of the invention, there is a possibility of personalizing the downloaded property. This can be done by inserting into the package a so-called watermark that carries the client's identity. Any copy subsequently made from it would carry the same watermark and thus will be traceable to that client. This procedure facilitates any distribution control measures that may be undertaken by the provider.

Another form of business conducted over the Internet is auctions. Typically, an auctioneer site offers merchandise, sometimes in the name of one or more client sellers, and bidders send in their bids. Problems that often arise include: (a) a successful bidder denies his bid, (b) a successful bidder fails to pay (except if payments are by means of credit accounts), (c) a seller fails to send the merchandise. These problems can largely be avoided by requiring every seller and every bidder to identify themselves to the auctioneer by means of the methods of the invention. In this case the response computer is preferably at the auctioneer's site. Alternatively, the response computer may be at the site of a mediation service provider, under an arrangement with the auctioneer. In any case, the identity of the parties are kept at the response computer in confidence.

It is noted that for most applications over the Internet, such as those discussed above, the level of security required is relatively low. Therefore the adapter used to connect a user's cell-phone to his computer may be a simple one, such as currently available commercially, without the additional security measures described further above.

It will be understood that many other embodiments and configurations of the devices and methods described are possible—all coming within the scope of the invention, which is defined by the claims that follow. In the method claims, roman numerals and alphabetic characters used to designate claim steps are provided for convenience only and do not imply any particular order of performing the steps.

It will also be understood that the method and the apparatus according to the invention may be one or more suitably programmed computers. Likewise, the invention contemplates one or more computer programs being readable by a computer for executing the method of the invention. The invention further contemplates a machine-readable memory tangibly embodying a program of instructions executable by the machine for executing the method of the invention.

1. A method for verifying the identity of a person seeking to gain access to a local computer, to any computer communicative therewith or to any facility accessible through any of these computers, the method comprising:
(i) Providing a cellular telephone, to be termed cell-phone, associated with a cellular network and registered to the person or legitimately in the person's possession, the cell-phone having at least one reference number stored therein;
(ii) Providing a direct communication link between said cell-phone and the local computer, the link possibly including an adapter;
(iii) Storing in any of the computers copies of one or more reference numbers stored in said cell-phone;
(iv) Reading any of the reference numbers stored in said cell-phone, comparing it with the corresponding one of said stored numbers and accordingly verifying the identity of the person.

2. The method of claim 1, wherein in step (ii) said communication link includes a wireless link.

3. The method of claim 1, wherein in step (ii) said communication link includes an adapter.

4. The method of any of claims 1-3, wherein one of the reference numbers is the unique hardware number of the cell-phone.

5. The method of any of claims 14, wherein one of the reference numbers is the call number of the cell-phone.

6. The method of any of claims 1-5, wherein the cell-phone has data storage memory and one of the reference numbers is any number or word stored in said memory.

7. The method of any of claims 1-6, wherein said communication link in step (ii) includes an adapter that includes at least one security means.

8. The method of claim 7, wherein said security means includes a number stored in said adapter, and further comprising:
(v) storing an adapter-identifying number in any of the computers;
(vi) reading said stored number from said adapter and comparing it with the number stored in step (v).

9. The method of claim 7 or 8, wherein said identification numbers stored in step (iii) are encrypted versions of the corresponding reference numbers, said security means includes an encryption module and step (iv) includes encrypting said any read reference number by means of said encryption module.

10. The method of any of claim 7-9, wherein said security means includes a lock that affects the communication between said cellular telephone and the local computer, and further comprising:
(vii) unlocking said lock be by the person before step (iv) can be carried out.

11. The method of any of claims 1-10, further comprising detecting whether step (iv) is being performed and, if affirmative, making a note, issuing a warning or signaling accordingly.

12. The method of any of preceding claims, wherein the local computer is a non-portable computer.

13. The method of any of the preceding claims, wherein the local computer is a portable computer.

14. The method of any of the preceding claims, wherein said reading of any reference number occurs through said communication link between said cellular telephone and the computer.

15. The method of any of the preceding claims, further comprising:
(viii) providing a telephone connection between the local computer and a dial-up network, the connection being associated with a dialing number;
and wherein step (iv) includes:
(a) sending a signal from the local computer to said cell-phone that causes the cell-phone to initiate a call to said dialing number, thereby causing at least one reference number stored in the cell-phone to be read out and transmitted over the cellular system;
(b) Receiving a call over said telephone connection;
(c) extracting from the received call any transmitted reference number.

16. The method of claim 15, wherein the received call is not answered.

17. The method of claim 16, wherein substep (a) of step (iv) includes manual intervention by the person, the intervention selected from among (1) pressing one or more buttons on said cell-phone, (2) pressing one or more keys on a keyboard of the local computer, (3) clicking on one or more locations on the display of the local computer.

18. The method according to any of claims 1-13 for verifying the identity of a person seeking to gain access through a local computer to any remote computer communicative therewith through a network, or to any facility accessible through the remote computer, the remote computer being termed a target computer, the method further comprising:
(ix) providing one or more telephone connections between any remote computer and a dial-up telephone network said remote computer being termed a response computer, the response computer being communicative with the local computer through the network and being communicative, or identical, with the target computer, and each of said telephone connections being associated with a dialing number; and
(x) transmitting one or more numbers, corresponding to said dialing numbers, to the local computer;
and wherein in step (iii) said storing includes storing in the response computer and step (iv) includes:
(d) sending a signal from the local computer to said cell-phone that causes the cell-phone to dial any of said dialing numbers of step (x), this operation initiating a call and causing at least one reference number stored in the cell-phone to be read and transmitted over the cellular system; and
(e) the response computer receiving the call initiated in substep (d) and extracting therefrom any transmitted reference number.

19. The method of claim 18, wherein in substep (e) the received call is not answered.

20. The method of claim 18, wherein steps (x) and (iv) are repeated periodically.

21. The method of claim 18, further comprising:
(xi) storing in the response computer one or more expected geographic locations of said cell-phone; and
(xii) obtaining the geographic location of said cell-phone and comparing it with said stored locations.

22. The method of claim 21, wherein the cellular system is capable of geographically locating any communicating cell-phone and in step (xii) said obtaining includes obtaining the location of said cell-phone from the cellular system.

23. The method of claim 21, wherein said cell-phone is equipped to sense its geographic location by means of a satellites-based system and in step (xii) said obtaining includes obtaining from said cell-phone its thus sensed location.

24. The method of claim 21, further including:
(xiii) providing at any of said expected locations one or more sensors for sensing radiation from said cell-phone and extracting therefrom its call number;
and wherein in step (xii) said obtaining includes obtaining from any of said sensors an indication as to the presence of said cell-phone at the corresponding location.

25. The method of any of claims 18-21, wherein in step (ix) there are provided a plurality of telephone connections and step (x) includes selecting said one of said dialing numbers from among all possible ones.

26. The method of claim 25, wherein in step (x) said transmitting is over the digital network or over the cellular system and said cell-phone.

27. The method of claim 25, wherein said transmitted numbers are not displayed and not retrievable.

28. The method of claim 25, wherein in step (x) the transmitted number is an encrypted version of the corresponding dialing number, the encryption key being specific to the person or to the local computer, and wherein substep (d) of step (iv) includes decrypting the transmitted number, to obtain said dialing number.

29. The method of claim 28, wherein said communication link in step (ii) includes an adapter and said decrypting is performed within said adapter.

30. The method of claim 28, wherein said decrypting is performed within said cell-phone.

31. The method of any of claims 18-30, further cooperating with any other security system

32. The method of any of claims 18-31, wherein the facility accessible through the target computer is a data-base management system or provision of a service, including an information service, or provision of an intellectual property.

33. The method of any of claims 18-32, wherein the response computer is identical to, or locally connected with, the target computer.

34. The method of claim 33, wherein the network is an open network, including the Internet, and the facility accessible through the target computer is e-mail authentication, the method further comprising receiving an e-mail message from the local computer, inserting into the received message a mark that certifies the person as being the originator and sending the message on.

35. The method of claim 34, wherein step (x) includes storing said transmitted numbers in the local computer.

36. The method of claim 33, wherein the network is an open network, including the Internet, and wherein steps (x) and (iv) are performed with respect to any person seeking access to the target computer after the target computer has sensed a massive attack on itself.

37. The method of claim 33, wherein the facility accessible through the target computer is digital signature authentication, the method further comprising receiving a document from the local computer and inserting into the document an indelible mark that certifies the person as being a signer of the document.

38. The method of claim 37, further comprising sending the document to another local computer for similar authentication.

39. The method of claim 33, wherein the facility accessible through the target computer is document delivery attestation, the method further comprising:
(xiv) receiving a document from a source;
(xv) sending said document to the local computer; and
(xvi) sending a corresponding delivery affirmation note to said source;
whereby step (xvi) is performed after step (iv).

40. The method of any of claims 18-32, wherein the facility accessible through the target computer is provision of an intellectual property, to be transmitted as a data package to the local computer, the method further comprising inserting into the data package an indelible identification number that uniquely corresponds to the identity of the person or to a registered number of said cell-phone.

41. The method of any of claims 18-32, wherein the network is an open network, including the Internet.

42. The method of claim 41, wherein the facility accessible through the target computer is selected from—
accessing a personal account managed by a commercial, medical or governmental organization,
using a restricted-access service, including a pre-paid service, and participation in a chat group.

43. The method of claim 41, wherein said response computer is distinct from said target computer and is associated with a mediation service.

44. The method of claim 43, wherein the facility accessible through the target computer is vending of merchandise or service and said mediation service is handling of credit-account transactions.

45. The method of claim 44, further comprising:
(xvii) sending transaction-related data from the target computer to the local computer and to the response computer;
(xviii) sending transaction-related data from the local computer to the response computer;
(xix) comparing between any of the data received by the response computer in steps (xvii) and (xviii) and between said received data and any stored credit-account data related to the person, to yield an approval verdict;
(xx) sending said approval verdict to the target computer and to the local computer.

46. The method of claim 44 or 45, further comprising:
(xxi) providing within the response computer a limited-access storage;
(xxii) transmitting transaction-related data from the local computer, over said cell-phone, the cellular network and said dialed telephone connection, to the response computer;
(xxiii) storing data transmitted in step (xxii) in said limited-access storage.

47. The method of claim 46, wherein the data transmitted in step (xxii) and stored in step (xxiii) includes data representing oral words spoken by the person.

48. The method of any of claims 43-47, whereby no credit-account numbers and/or no data identifying the person is communicated to the target computer.

49. The method of any of claims 4348, wherein the target computer is associated with a corporate entity, the method further comprising:
(xxiv) authenticating the identity of the corporate entity, associated with the target computer, with respect to the response computer;
(xxv) sending to the local computer a corroboration of the identity of the corporate entity.

50. The method of claim 49, wherein in step (xxiv) said authenticating includes:
(a) Providing a cell-phone, associated with a cellular network and registered to the corporate entity, the cell-phone having at least one reference number stored therein;
(b) Providing a direct communication link between said cell-phone and the target computer, the link possibly including an adapter;
(c) Storing in the response computer copies of one or more reference numbers stored in said cellular telephone;
(d) Reading any of the reference numbers stored in said cell-phone and comparing it with the corresponding one of said stored numbers.

51. The method of claim 33, wherein the facility accessible through the target computer is an auction and the person is a seller, who offers an item for sale through the facility, or a buyer, who submits a bid for an item offered for sale through the facility, the method further comprising storing at the target computer, in association with the person's identity, if a seller—any data related to the item, or, if a buyer—any bid submitted by the person for the item.

52. A method for verifying the identity of a person seeking to gain access through a local computer to any remote computer communicative therewith through a network, or to any facility accessible through the remote computer, the method comprising:
(viii) Providing a cellular telephone, to be termed cell-phone, associated with a dial-up cellular network and registered to the person or legitimately in the person's possession, the cell-phone having at least one reference number stored therein;
(ix) Providing a direct communication link between said cell-phone and the local computer;
(x) providing at any remote computer one or more dial-up telephone connections, said remote computer being termed a response computer, the response computer being communicative with the local computer through the network,
(xi) Storing in the response computer copies of one or more reference numbers stored in said cell-phone;
(xii) causing the local computer to command said cell-phone, through said link, to initiate a call to any of said telephone connections and to thereby cause at least one reference number stored in the cell-phone to be read out and transmitted;
(xiii) the response computer receiving the call initiated in step (v) and extracting therefrom any transmitted reference numbers; and
(xiv) comparing any reference number extracted in step (vi) with the corresponding one of said stored numbers and accordingly verifying the identity of the person.

53. An access controlled computer—
directly linkable to a cellular telephone that has at least one reference number stored therein, the link possibly including an adapter;
having stored therein copies of one or more of said reference numbers; and
configured to automatically obtain from a cell-phone linked thereto any reference numbers stored therein, to compare it with said stored copies and accordingly to verify the identity of a person seeking to gain access to the computer or to any computer communicative therewith or to any facility accessible through any of these computers.

54 The computer of claim 53, one of said reference numbers being the unique hardware number of the cell-phone.

55. The computer of claim 53 or 54, one of said reference numbers being the call number of the cell-phone.

56 The computer of any of claims 53-55, being linkable to a cellular telephone through an adapter, which has a number permanently stored therein;
the computer having an adapter-identifying number stored therein and being further configured to automatically retrieve the number stored in said adapter and to compare it with said adapter-identifying number.

57 The computer of claim 53, connectable to a dial-up telephone network, the connection being associated with a dialing number, and being further configured—
to automatically send a signal to any linked cell-phone, such that will initiate a call to said dialing number, thereby causing at least one reference number stored in the cell-phone to be read out and transmitted over the cellular system with which it is in communication; and
to receive a call from said telephone network and to extract therefrom any transmitted reference number of the cell-phone.

58. A local computer for controllably accessing any remote computer communicative therewith through a network, or any facility accessible through the remote computer, the local computer being—
directly linkable to a cellular telephone that has at least one reference number stored therein, the link possibly including an adapter, and
configured to obtain a dialing number from a remote computer and to automatically send a signal to any linked cell-phone, such that will initiate a call to said dialing number, thereby causing at least one reference number stored in the cell-phone to be read and transmitted over the cellular system with which it is in communication.

59. The computer of claim 58, being linkable to a cellular telephone through an adapter, which has a number permanently stored therein;
the computer having an adapter-identifying number stored therein and being further configured to automatically retrieve the number stored in said adapter and to compare it with said adapter-identifying number.

60. An access controlling computer, connectable to a digital network and having one or more telephone connections to a dial-up telephone network, each telephone connection being associated with a dialing number, the computer being configured—
to communicate with any other computer, termed “requesting computer”, on the digital network about gaining access by a requesting person through the requesting computer to any computer on the network or to any facility provided thereby;
to store copies of cellular reference numbers and other data pertaining to persons having permission to access any computer on the network or to access or use any facility provided thereby; and
to receive a call over any of the telephone connections, to check whether the call originated from a cellular telephone, to extract therefrom any reference number transmitted from the cellular telephone, to compare any such extracted number with said stored copies and to accordingly verify the identity of said requesting person.

61. The access controlling computer of claim 60, being further configured to store acceptable cellular locations in association with said data pertaining to persons, to extract from said received call location data provided by the cellular system and to compare such location data with said stored cellular locations.

62. The computer of claim 60 or 61, being further configured to select any one of said dialing numbers, to encrypt it and to send it to the requesting computer.

63. The access controlling computer of any of claims 60-62, wherein said any facility includes a data-base management system or provision of a service, including an information service, or provision of an intellectual property.

64. The access controlling computer of any of claims 60-62, wherein said any facility includes a document authentication function, the computer being further configured to receive a document from a person through the requesting computer and to insert into the document an indelible mark that certifies the person as being a signer of the document.

65. The access controlling computer of any of claims 60-62, wherein said any facility includes provision of an intellectual property, to be transmitted as a data package to the requesting computer, for use by a person, the computer being further configured to insert into the data package an indelible identification code that uniquely corresponds to the identity of the person.

66. The access controlling computer of any of claims 60-65, also comprising, or being communicative with, a security management facility and being further configured to coordinate any of the claimed functions with said security management facility.

67. The access controlling computer of any of claims 60-65, wherein the digital network is an open network, including the Internet.

68. The access controlling computer of claim 67, wherein said any facility includes e-mail authentication, the computer being further configured to receive an email message from a person through the requesting computer, to insert therein an indelible mark that certifies the person as being the originator and sending the message on.

69. The access controlling computer of claim 67, wherein said any facility includes auction management over the network, the computer being further configured to receive from the requesting computer data about an item offered to be auctioned or a bid for an item being auctioned and to store any of them in association with identification data or with a cell-phone reference number.

70. The access controlling computer of claim 67, wherein said any facility includes handling of credit-account transactions, the computer being further configured to receive, with respect to any transaction conducted over the network between a person at the requesting computer and any vending node, data pertaining to the transaction from both the requesting computer and the vending node and to use the received data, as well as the stored data pertaining to the person, in the process of approving the transaction to the vending node.

71 The access controlling computer of claim 70 comprising a limited-access storage and further configured to receive data pertaining to the transaction from the requesting computer over any of said telephone connections and to store any such data in said limited-access storage.

72. The access controlling computer of claim 71 wherein the data received over the telephone connection and stored in the limited-access storage includes data representing oral words spoken by the requesting person.

73. The access controlling computer of any of claims 70-72, the vending node
being associated with a corporate entity, the computer being further configured to store cellular vendor reference numbers and other data pertaining to the corporate entity associated with the vending node;
to send a dialing number, or an encrypted version thereof, to the vending node; and
to receive a call over the telephone connection associated with said dialing number, to check whether the call originated from a cellular telephone, to extract therefrom any reference number transmitted from the cellular telephone, to compare any such extracted number with said stored cellular vendor reference numbers and to use the results of the comparison in corroborating the authenticity of the corporate entity to the requesting computer.

74. The access controlling computer of claim 67, wherein said any facility includes site authentication and the requesting computer is associated with a corporate entity, the access controlling computer being further configured to send to any other node a corroboration of the authenticity of the corporate entity.

75. An adapter, operative to transmit data between a computer and a cell-phone, comprising at least one security means.

76. The adapter of claim 75, wherein said security means includes a number permanently stored in the adapter and readable from the computer.

77. The adapter of claim 75, wherein said security means includes a lock that affects the data transmission between the cellular telephone and the computer.

78. The adapter of claim 77, wherein the means of unlocking said lock is selectable from a group including—
a password code sent from the computer,
a password code entered manually into a keypad on the adapter,
a card readable by the lock or by any other component of the adapter,
a key physically interacting with the lock or with any other component of the adapter.

79. The adapter of claim 75, wherein said security means includes a decryption means, operative to decrypt any data transmitted from the computer to the cell-phone or to encrypt any data sent from the cell-phone to the computer.

80. The adapter of claim 79, wherein said decryption means is operative to decrypt any dialing number transmitted to the cell-phone.

81. A controller, connectable to a computer, termed response computer, that is, in turn, connectable to a computer network, there being linked to any other computer connected to the network at least one cellular telephone, communicative with a cellular network and having one or more reference numbers stored therein which are readable during a call dialed therefrom, said response computer having one or more telephone connections to a dial-up telephone network, each telephone connection being associated with a dialing number, the controller being operative—
to receive a call over any one of the telephone connections,
to check whether the call originated from a cellular telephone and to extract therefrom any reference number transmitted from the cellular telephone, and
to convey any extracted reference number to said response computer.

82. The controller of claim 81, being further operative to extract from said received call location data provided by the cellular system.

83. The controller of claim 81 or 82, being further operative to select any of said dialing numbers, to encrypt it and to cause it to be sent to another computer on the digital network.

84. An access controlled digital system, comprising a plurality of computers,
inter-connected by a network, and one or more telephone lines, connected to a dial-up telephone network, each line being associated with a dialing number;
at least one of the computers being a requesting computer, operated by a requesting person, and at least one of the computers being a responding computer;
each responding computer being connectable to one or more of said telephone lines and being operative—
to store cellular reference numbers and other data pertaining to persons having permission to access said responding computer or to access or use any facility provided therein,
to select a dialing number corresponding to one of said lines, to send it to any requesting computer with which it communicates, and
to receive a call over the telephone connection associated with said selected dialing number, to check whether the call originated from a cellular telephone, to extract therefrom any reference number transmitted from the cellular telephone, to compare any such extracted number with said stored cellular reference numbers and to accordingly verify the identity of said requesting person; and
each requesting computer being connectable to a cellular telephone, either directly or through an adapter, and configured—
to obtain a dialing number from a responding computer with which it communicates and
to automatically send a signal to any linked cell-phone, such that will cause the cell-phone to dial said dialing number, thereby causing at least one reference number stored in the cell-phone to be read and transmitted over the cellular system with which it is in communication.

85. The method of claim 33, wherein the facility accessible through the target computer is approval of credit-account transactions, the local computer is located at a place of business and the person is a customer who seeks the access in order to gain approval of payment through his credit account for a transaction at the place of business.

86. The method of claim 85, wherein there is also data from the person's credit card sent to the target computer and the decision on the approval of payment is based, inter alia, on said comparison in step (iv) and on said data from the credit card.

87. A method for approving a credit account payment by a person for a transaction at a place of business, the approval being by a remote approval agency that is associated with a computer, the method comprising:
(xv) Providing a cell-phone, associated with a cellular network and registered to the person or legitimately in the person's possession, the cell-phone having at least one reference number stored therein;
(xvi) Storing in the computer, in association with other data related to the person, one or more identification numbers corresponding to reference numbers stored in said cellular telephone;
(xvii) providing one or more telephone connections between the computer and a dial-up telephone network each of said telephone connections being associated with a dialing number;
(xviii) dialing one of said dialing numbers of step (xxviii) by said cell-phone, this operation initiating a call and causing at least one reference number stored in the cell-phone to be read and transmitted over the cellular system;
(xix) the computer receiving the call initiated in step (xxix) and extracting therefrom any transmitted reference number;
(xx) retrieving from the computer's storage any one of said identification numbers that corresponds to the number extracted in step (xxx), together with any of said associated data, and using said retrieved data in the process of approval.

88. The method of claim 87, further comprising communicating the number to be dialed in step (xxix) from the computer or the agency to the person.

89. The method of claim 88, wherein said communicating is by means of said cell-phone.

90. The method of claim 87, wherein the number to be dialed in step (xxix) is displayed at the place of business.

91. The method of claim 90, wherein the place of business is a vending machine that has a keyboard, the method further comprising:
(xxi) communicating a code from the computer or the agency to the person by means of said cell-phone;
(xxii) the person keying said code into the keyboard of the vending machine.

92. For use in any of the method claims 15-17—steps (iii), (viii) and substeps (b) and (c) of step (iv).

93. For use in any of the method claims 18-52—steps (iii), (ix), and (x) and substep (e) of step (iv).

94. For use in any of the method claims 21-51—steps (xi) and (xii).
